(19) United States
(12) Patent Application Publication
(10) Pub. No.: US 2013/0305960 A1
(43) Pub. Date: Nov. 21, 2013

(54) Process for forming a coating layer on a substrate and coating composition therefor

(71) Applicants: John L. Edwards, Durham (GB); Karl Lowry, Stockton-on-Tees (GB); John Robb, Stockton-on-Tees (GB)

(72) Inventors: John L. Edwards, Durham (GB); Karl Lowry, Stockton-on-Tees (GB); John Robb, Stockton-on-Tees (GB)

(73) Assignee: Tioxide Europe Limited, Wynyard Park (GB)

(21) Appl. No.: 13/982,633

(22) PCT Filed: Jan. 24, 2012
(86) PCT No.: PCT/GB12/50151

§ 371 Date: Jul. 30, 2013

(30) Foreign Application Priority Data
Feb. 3, 2011 (GB) 1101818.1

(51) Int. Cl. C09D 5/00; B05D 7/24

(52) U.S. Cl. CPC C09D 5/00; B05D 7/24
USPC 106/287.19; 427/553; 427/557

(57) ABSTRACT

A process for forming a coating layer on a substrate comprising: depositing a thin film of a concentrated aqueous nano titania sol onto at least a portion of the substrate; exposing at least a portion of the deposited film to a sufficient amount of ultraviolet radiation in order to gel the film of aqueous sol; and drying at least a portion of the gelled portion, thereby forming the coating layer.

### BACKGROUND OF THE INVENTION

1. Field of the Invention

The present invention relates generally to coating compositions. More specifically, the present invention relates to a process for forming a coating layer on a substrate from a coating composition comprising a nano titania sol.

2. Background Information

Thin inorganic oxide films are currently being used in a number of different technologies. For example, these films are used in the manufacture of touch screen and flat panel displays, organic light emitting diode (OLED) lighting, and solar cells. These inorganic films, however, are typically applied to the desired substrate using techniques such as electron beam evaporation, vapor deposition, or sputter deposition. While these techniques have been used in the manufacture of the aforementioned technologies, a few shortcomings are associated with these methods. For example, a common shortcoming is the costs that are typically associated with the equipment used in the various processes. Additionally, there are inherent limitations with these processes since some can only be used in certain situations.

### SUMMARY OF THE INVENTION

The present invention is directed to a process for forming a layer on a substrate comprising:

depositing a thin film of a concentrated aqueous sol onto at least a portion of the substrate, wherein the concentrated aqueous nano titania sol is formed by the process comprising:
(a) contacting an acidic nano titania sol with: (i) a dispersant comprising a water soluble carboxylic acid, a water soluble salt of a carboxylic acid, a water soluble polycarboxylic acid, or combinations thereof; and (ii) an alkalizing agent, thereby forming a pH adjusted nano titania sol, wherein the pH adjusted nano titania sol is in a range of between about 4.0 and about 10.0; and
(b) subjecting the pH adjusted nano titania sol to membrane filtration and continuing such membrane filtration until the nano titania sol contains more than 300 g TiO₂ nanoparticles/dm³, thereby forming the concentrated aqueous nano titania sol;

exposing at least a portion of the deposited film to a sufficient amount of ultraviolet radiation in order to gel the concentrated aqueous nano titania sol; and

drying at least a portion of the gelled portion of the dispersion thereby forming the coating layer.

The present invention is also directed to a substrate that is at least partially coated with a coating layer formed by a process comprising:

depositing a thin film of a concentrated aqueous sol onto at least a portion of the substrate, wherein the concentrated aqueous nano titania sol is formed by the process comprising:
(a) contacting an acidic nano titania sol with: (i) a dispersant comprising a water soluble carboxylic acid, a water soluble salt of a carboxylic acid, a water soluble polycarboxylic acid, or combinations thereof; and (ii) an alkalizing agent, thereby forming a pH adjusted nano titania sol, wherein the pH adjusted nano titania sol is in a range of between about 4.0 and about 10.0; and
(b) subjecting the pH adjusted nano titania sol to membrane filtration and continuing such membrane filtration until the nano titania sol contains more than 300 g TiO₂ nanoparticles/dm³, thereby forming the concentrated aqueous nano titania sol;

exposing at least a portion of the deposited film to a sufficient amount of ultraviolet radiation in order to gel the concentrated aqueous nano titania sol; and

optionally, drying at least a portion of the gelled portion of the concentrated aqueous nano titania sol; and

exposing at least a portion of the gelled portion or, optionally, dried portion of the dispersion to thermal treatment thereby forming the coating layer.

The present invention is also directed to a coating composition formed by the process comprising:
(a) contacting an acidic nano titania sol doped with up to 20% of elements from groups VA & VB of the periodic table with: (i) a dispersant comprising a water soluble carboxylic acid, a water soluble salt of a carboxylic acid, a water soluble polycarboxylic acid, or combinations thereof; and (ii) an alkalizing agent, thereby forming a pH adjusted nano titania sol, wherein the pH adjusted nano titania sol is in a range of between about 4.0 and about 10.0; and
(b) subjecting the pH adjusted nano titania sol to membrane filtration and continuing such membrane filtration until the nano titania sol contains more than 300 g TiO₂ nanoparticles/dm³, thereby forming the coating composition.

### BRIEF DESCRIPTION OF THE DRAWINGS

A full understanding of the invention can be gained from the following description of certain embodiments of the invention when read in conjunction with the accompanying drawing in which:

FIG. 1 is a TiO₂ ultraviolet (UV) absorbance spectra.

### DETAILED DESCRIPTION OF THE INVENTION

As used herein, unless otherwise expressly specified, all numbers such as those expressing values, ranges, amounts or percentages may be read as if prefaced by the word “about”, even if the term does not expressly appear. Plural encompasses singular and vice versa. For example, although reference is made herein to “an” acidic nano titania sol, “a” water soluble carboxylic acid, “a” water soluble polycarboxylic acid, “an” alkalizing agent, a combination (a plurality) of these components can be used in the present invention.

As used herein, “plurality” means two or more.

As used herein, “includes” and like terms means “including without limitation.”

When referring to any numerical range of values, such ranges are understood to include each and every number and/or fraction between the stated range minimum and maximum. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

### Process for Forming a Coating Layer

Traditionally, formation of an inorganic oxide coating layer onto a substrate from an aqueous sol, in a manner that is substantially free of cracks can be difficult to accomplish due to the natural stresses that develop as the deposited film dries. As used herein, “free of cracks” means that a visual inspection using an optical microscope of a 5 cm×5 cm square area shows there exists an uninterrupted titania path across the coating layer between any two opposite sides of the square. As the stresses increase, the coating film reaches a critical breakpoint where cracks begin to appear in the drying coating layer.

It has been surprisingly found that by use of the process disclosed herein, a thin substantially crack free inorganic oxide film or layer may be formed from a colloidal dispersion of particles, such as nano titania particles. In certain embodiments, the dry film thickness of the coating layer ranges from 0.1 microns to 200 microns, such as from 1 micron to 50 microns or 5 microns to 20 microns. At some of these dry film thicknesses, it was observed that the coating layer exhibited a degree of flexibility which would be useful in the manufacture of articles in the industries discussed above. As used herein, flexibility is determined by coating an A4 (210 mm×297 mm) sheet of PET that has been coated with the coating layer disclosed herein and rolling the sheet to make a cylinder having a radius of 5 cm. The rolled cylinder is then unrolled back to its original configuration and a visual inspection is conducted to see whether the coating layer has detached from the PET substrate. If the coating layer has not detached, then it is concluded that the coating layer is flexible.

The present invention is directed to a process of forming a coating layer on a substrate wherein at least a portion of a substrate is coated with a concentrated aqueous nano titania sol. That is, a thin film of an aqueous sol (i.e., colloidal dispersion) comprising nano titania particles is deposited onto at least a portion of the substrate. The thin film may be deposited onto some or all of the surface of the substrate. In certain embodiments, the aqueous sol is deposited at a wet film thickness ranging from 0.8 microns to 1600 microns (e.g. from 1 micron to 1000 microns), such as from 8 microns to 400 microns, such as from 40 microns to 160 microns. As used herein, “nano titania sol” refers to a colloidal suspension of TiO₂ nanoparticles or nano titania particles having a mean particle size of less than 100 nm (e.g. from 1 nm to less than 100 nm), such as less than 50 nm. Accordingly, in certain embodiments, the mean particle size can range from 10 nm to 50 nm (e.g., from 30 nm to 50 nm). Particle size can be determined by X-ray sedimentation. The TiO₂ nanoparticles may be anatase, rutile or amorphous or a mixture thereof. Additionally, the aforementioned TiO₂ nanoparticles or nano titania particles may also be doped with a compound. For example, these nanoparticles can be doped with up to 20% (e.g. from 0.1 to 20%) by weight of an element selected from the groups VA & VB of the periodic table based on the total weight of the nanoparticle. In certain embodiments, the nanoparticle can be doped with up to 20% (e.g. from 0.1 to 20%) by weight of Niobia, based on the total weight of the nanoparticle. In certain embodiments, the nano titania sol is present in the concentrated aqueous sol at a concentration 500 grams per liter (gpl) such as 700 gpl. In certain embodiments, the nano titania sol is present in the concentrated aqueous sol at a concentration from 500 gpl to 2000 gpl.

The concentrated aqueous nano titania sol is formed by a process comprising contacting an acidic nano titania sol with: (a) a dispersant comprising a water soluble carboxylic acid, a water soluble salt of a carboxylic acid, a water soluble polycarboxylic acid, or combinations thereof; and (b) an alkalizing agent, thereby forming a pH adjusted nano titania sol, wherein the pH adjusted nano titania sol is in a pH range of between about 4.0 and about 10.0.

Substantially all of the steps of the process of forming the concentrated aqueous nano titania sol may be performed at temperatures below 100° C. thus making their implementation into a commercial setting simple and economical. The concentrated aqueous nano titania sol produced by the process disclosed herein demonstrates exceptional stability over a wide pH range, especially at a mild pH range of 6 to 8, making the sol safe and easy to use. Moreover, the concentrated aqueous nano titania sol does not exhibit agglomeration and therefore does not require a milling step to exhibit excellent translucency. Furthermore, even though the nano titania sol is concentrated, it still possesses low viscosity making it particularly suitable for pumping, shipment and direct use.

In certain embodiments, an acidic nano titania sol is provided. The acidic nano titania sol may be provided from any means so long as it contains an acidic colloidal suspension of TiO₂ nanoparticles. The TiO₂ nanoparticles colloidally suspended may be produced from anatase, rutile or amorphous TiO₂ which has been prepared by any suitable process. Typical processes may involve hydrolysis of an appropriate titanium compound, such as, titanium tetrachloride, titanyl sulphate or an organic or inorganic titanate, or oxidation of an oxidizable titanium compound, for example, in the vapour state.

In one embodiment, the acidic nano titania sol is produced from TiO₂ prepared by a precipitation step in a sulphate process. After precipitation, the obtained titania hydrate is filtered, washed free of impurities, and contacted with an aqueous base to form a suspension having a pH of about neutral. Sulphate ions are then removed from the neutralized suspension by filtration and washing. In one aspect, the filter cake obtained after filtration is washed until the SO₄²⁻ content of the wash filtrate is less than 0.001 g/l (which may be determined by barium chloride solution titration). The washed filter cake is then slurried in water to produce a substantially sulphate-ion-free aqueous suspension of titania hydrate which is then peptized with a strong monoprotic acid pH adjustment to a pH of about 2.0 or below (e.g. from about 1.0 to about 2.0), preferably a pH of about 1.5, to provide the acidic nano titania sol.

The acidic nano titania sol is then contacted with the aforementioned dispersant and with an alkalizing agent. The acidic nano titania sol may be contacted with the dispersant and alkalizing agent in any order or in combination.

According to one embodiment, the acidic nano titania sol is first contacted with the dispersant. As stated above, the dispersant comprises at least one of a water soluble carboxylic acid, a water soluble salt of a carboxylic acid, and a water soluble polycarboxylic acid. In one embodiment, the water soluble carboxylic acid is an α-hydroxy carboxylic acid. The α-hydroxy carboxylic acid may comprise one, two or three carboxylic acid groups, and includes without limitation, lactic acid, glycolic acid, malic acid, tartaric acid, mandelic acid and citric acid. In another embodiment, the water soluble carboxylic acid is a β-hydroxy carboxylic acid. In still another embodiment, the water soluble polycarboxylic acid is a dicarboxylic acid or a tricarboxylic acid. In other embodiments, the dispersant comprises one or more salts of the foregoing acids.

The acidic nano titania sol and dispersant may be contacted by any suitable means, such as conventional mixing in a vessel, for a period of time of at least about 0.1 hours, preferably at least about 0.25 hours and more preferably at least about 0.5 hours. In another embodiment, the acidic nano titania sol and dispersant may be contacted for a period of time of less than about 24 hours, preferably less than about 12 hours, and more preferably less than about 3 hours. In still another embodiment, the acidic nano titania sol and dispersant may be contacted for a period of time of between at least about 0.5 hours to less than about 3 hours.

The acidic nano titania sol is also contacted with an alkalizing agent. In one embodiment, the acidic nano titania sol is contacted with the alkalizing agent after contacting with the dispersant. Examples of alkalizing agents include alkanolamines, preferably water soluble alkanolamines such as isopropanolamine, and choline hydroxide. The period of time which the acidic nano titania sol is contacted with the alkalizing agent is a period of time sufficient to fully adjust the pH of the acidic nano titania sol to a pH in the range of between about 4.0 and about 10.0.

The pH adjusted nano titania sol is then subjected to the effects of membrane filtration, preferably crossflow filtration or crossflow filtration with vibration, to obtain a concentrated nano titania sol containing at least 300 g TiO₂ nanoparticles/dm³. In other embodiments, the nanotitania sol is subjected to the effects of membrane filtration to obtain a concentrated nano titania sol containing at least 500 g TiO₂ nanoparticles/dm³, such as at least 550 g TiO₂ nanoparticles/dm³ or at least 600 g TiO₂ nanoparticles/dm³ or at least 700 g TiO₂ nanoparticles/dm³. In certain embodiments, the concentrated nano titania sol has a viscosity of about 0.001 Pa s to about 0.2 Pa s at 20° C. The solids content of the acidic nano titania sol which is the feedstock for membrane filtration will generally be less than about 350 g TiO₂ nanoparticles/dm³. Thus, in one embodiment, the solids content of the acidic nano titania sol feed stock ranges between at least about 100 g TiO₂ nanoparticles/dm³ to less than about 350 g TiO₂ nanoparticles/dm³.

Optionally, the pH adjusted nano titania sol may be contacted with a washing agent, for example water, preferably demineralized water, any time during the membrane filtration step to remove a portion of or substantially all soluble salts from the nano titania sol. In one embodiment, the pH adjusted nano titania sol is contacted with the washing agent during step (b) prior to concentrating the nano titania sol. In another embodiment, the pH adjusted nano titania sol is contacted with the washing agent after concentrating the nano titania sol. The reduction of water soluble salts from the nano titania sol assists in producing a concentrated nano titania sol having a desirably low conductivity. In one aspect, the nano titania sol is contacted with the washing agent during step (b) for a period of time sufficient to reduce the nano titania sol's conductivity to less than 10 mS/cm (e.g. from 0.1 to less than 10 mS/cm), such as less than 5 mS/cm or less then 2 mS/cm.

After deposition of the concentrated aqueous nano titania sol onto at least a portion of the substrate, the concentrated aqueous nano titania sol is subjected to or exposed to a sufficient amount of ultraviolet radiation in order to gel the concentrated aqueous nano titania sot. For example, in certain embodiments, the concentrated aqueous nano titania sol is exposed to ultraviolet radiation for a time period ranging from 0.01 second to 300 seconds (e.g. from 0.05 seconds to 100 seconds), such as from 0.1 second to 10 seconds, in order to gel the sol. Various sources known in the art can be used to emit the ultraviolet radiation needed to gel the concentrated aqueous nano titania sot. For example, ultraviolet radiation sources known in the art, such as light emitting diodes (LEDs), mercury lamps, xenon lamps, or even sunlight, can all be used to emit the ultraviolet radiation used in the present invention.

After a portion of the concentrated aqueous nano titana sol has been gelled, at least a portion of the gelled portion is dried (i.e. some or all of the gelled portion is dried). As used herein, the drying step can involve drying the gelled portion at a temperature that is ≦200° C., such as from 0° C. to 200° C., and/or it can involve drying the gelled portion by thermal treatment. As used herein, “thermal treatment”, which also includes sensible heating, means that the titania, but not necessarily the substrate, is heated to a temperature in excess of 200° C., such as from 201° C. to 1800° C. Suitable examples of apparatuses that may be used in the drying and/or heating step include thermal ovens, microwave ovens, infrared lamps, or an ultraviolet radiation source such as those described above. The thermal treatment may optionally be carried out under a reducing atmosphere. In certain embodiments, the gelled portion of the concentrated aqueous nano titania sol is subjected to thermal treatment for from 1 second to 1000 seconds, such as from 1 second to 10 seconds. It should be understood that the thermal treatment step, in certain embodiments, involves the superficial melting of at least some of the titania in the deposited film thereby producing an extensively fused film such as a fully fused film. In other embodiments, the gelled portion of the concentrated aqueous nano titania sol is subjected to a drying step at temperature ≦200° C. (such as from 0° C. to 200° C.) for 1 second to 1000 seconds, such as from 1 second to 10 seconds, before being subjected to the aforementioned thermal treatment step. In yet other embodiments, the gelled portion of the concentrated aqueous nano titania sol is only subjected to a drying step at a temperature ≦200° C. (such as from 0° C. to 200° C.) for 1 second to 1000 seconds, such as from 1 second to 10 seconds, and is not subjected to a thermal treatment step. In yet other embodiments, the gelled portion of the concentrated aqueous nano titania sol is only subjected or exposed to thermal treatment, which has effects of both drying and fusing.

The coating layer that is formed using the method disclosed herein surprisingly exhibited higher critical cracking thicknesses when compared to coating films that are known in the art. In other words, in some embodiments, the present invention can yield a coating layer that is substantially crack free while having a thin dry film thickness. In addition to being substantially crack free, the coating layer of the present invention is also substantially continuous. As used herein, “substantially continuous” means that the electrical resistance of the coating layer is <5×10⁻³ ohm cm (e.g. 0<electrical resistance<5×10⁻³ ohm cm). It was also found that the coating layer formed by the process disclosed herein is photoactive. As used herein, “photoactive” means the ability of an object (e.g., the coating layer) to generate free radicals in adjacent materials (e.g., substrate) when the object is subjected to irradiation with light.

Various substrates may be coated with the aforementioned concentrated aqueous nano titania sol using the method disclosed herein. For example, in certain embodiments, the concentrated aqueous nano titania sol can be deposited onto a glass substrate or transparency. The coating disclosed herein can be used in a number of articles of manufacture such as handheld electronic devices (cellular phones, “smart phones”), transparencies, touch screen and flat panel displays, organic light emitting diode lighting, solar cells, and self cleaning windows/tiles.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof. Therefore, any of the features and/or elements which are listed above may be combined with one another in any combination and still be within the breadth of this disclosure.

### EXAMPLES

Example 1

Illmenite is digested with concentrated sulphuric acid to obtain a digestion cake. The digestion cake is dissolved in water to form a crude liquor containing iron sulphates, titanium sulphate and some suspended insoluble matter. The iron in ferric form is then reduced chemically and the liquor filtered to remove insoluble matter. The liquor is then concentrated by vacuum treatment and hydrolyzed to precipitate hydrous titania by heating and the addition of nucleating agents. Up to this point the reader will recognize that these steps correspond to the “sulphate process” and in fact any suitable variant of the sulphate process may be used. The nuclei level employed can be adjusted to tune the detailed properties of the product film. The hydrous titania is separated from impurities by washing and filtration and a titania hydrate suspension is then obtained by mixing the hydrous filter coke with demineralized water. The titania hydrate suspension (pH<2) is then neutralized with ammonia to a pH of about 7, filtered and washed with water to remove sulphate compounds and reslurried in water. The pH of the slurry is then taken to a pH<2.0 by the addition of hydrochloric acid to produce an acidic nano titania sol. The acidic nano titania sol is then contacted with citric acid (1.0 g citric acid per 10 g TiO₂) by mixing in a vessel for approximately 30 minutes. The sol is then contacted with monoisopropanolamine by mixing in a vessel for a period of time sufficient to adjust the pH of sol to about 7.0-8.0. The pH adjusted nano titania sol is then subjected to cross-flow filtration by first contacting the sol with water to remove soluble salts and then continuing crossflow filtration until the sol contains more than 500 g TiO₂ nanoparticles per dm³ based on the total weight of the aqueous sol. The sol had a viscosity of 0.026 Pa s and a modal particle size of 43 nm measured using a Disc centrifuge. The pH of the sol is 8.2.

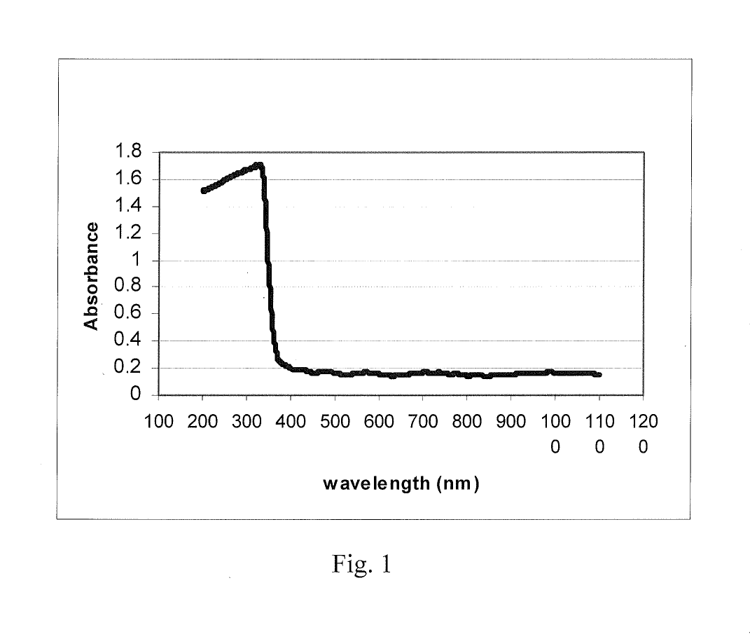

The sol was draw down onto a glass plate, in a high humidity atmosphere, using a zero K-bar applicator. When dried such a TiO₂ film has the absorbance spectra shown in FIG. 1. The high UV absorbance of such a film can improve the lifetime of an article incorporating is product exposed to solar radiation. The wet film, in a high humidity environment, was irradiated for 15 minutes using a Blacklight fluorescent tube at 20 cm distance. The film was dried over 2 hrs at room temperature. The absorbance of the film was then measured as a function of wavelength. The dried film was then heated in an oven for 2 hours at 600° C.

### Example 2

A dried film was prepared in a manner identical to that described in Example one except the final heating step was carried out in a microwave heating system operating at a frequency of 2.45 GHz, the heating time was 5 minutes.

1. A process for forming a coating layer on a substrate comprising:
depositing a thin film of a concentrated aqueous nano titania sol onto at least a portion of the substrate, wherein the concentrated aqueous nano titania sol is formed by the process comprising:
(a) contacting an acidic nano titania sol with: (i) a dispersant comprising a water soluble carboxylic acid, a water soluble salt of a carboxylic acid, a water soluble polycarboxylic acid, or combinations thereof; and (ii) an alkalizing agent, thereby forming a pH adjusted nano titania sol, wherein the pH adjusted nano titania sol has a pH in a range of between about 4.0 and about 10.0; and
(b) subjecting the pH adjusted nano titania sol to membrane filtration and continuing such membrane filtration until the pH adjusted nano titania sol contains more than 300 g TiO₂ nanoparticles/dm³, thereby forming the concentrated aqueous nano titania sol;
exposing at least a portion of the deposited film to a sufficient amount of ultraviolet radiation in order to gel the concentrated aqueous nano titania sol; and
drying at least a portion of the gelled portion, thereby forming the coating layer.

2. The process according to claim 1, wherein subsequent to the drying step, the process comprises subjecting at least a portion of the dried portion of the concentrated aqueous nano titania sol to a temperature greater than 200° C. for 1 second to 1000 seconds.

3. The process according to claim 1, wherein the drying step only comprises subjecting at least a portion of the gelled portion of the concentrated aqueous nano titania sol to thermal treatment.

4. The process according to claim 1, wherein the acidic nano titania sol comprises a nano titania comprising an anatase crystal structure.

5. A process according to claim 1, wherein the acidic nano titania sol comprises a nano titania, and wherein the nano titania is doped with up to 20% by weight of an element selected from the groups VA & VB of the periodic table based on the total weight of the nano titania.

6. A process according to claim 1, wherein the acidic nano titania sol comprises a nano titania, and wherein the nano titania is doped with up to 20% by weight of niobia based on the total weight of the nano titania.

7. The process according to claim 1 wherein thermal treatment is performed and the thermal treatment is performed under a reducing atmosphere.

8. The process according to claim 1, wherein the acidic nano titania sol comprises a nano titania, and wherein the particle size of the nano titania is less than 100 nm.

9. The process according to claim 1, wherein the alkalizing agent is a water soluble alkanolamine or choline hydroxide.

10. A substrate that is at least partially coated with a coating layer that is formed by the process of claim 1.

11. A substrate according to claim 10 wherein the substrate comprises a product selected from: handheld electronic devices, transparencies, touch screen and flat panel displays, organic light emitting diode lighting, solar cells, self-cleaning windows, and self-cleaning tiles.

12. The process according to claim 1, wherein the ultraviolet radiation comprises UV-A, UV-B, UV-C or X-Rays.

13. The process according to claim 1, wherein the aqueous nano titania sol further comprises a co-solvent, humectant, or combinations thereof.

14. The process according to claim 1, wherein thermal treatment is performed and comprises using sensible heating, microwave heating, or combinations thereof.

15. A substrate that is at least partially coated with a coating layer, formed by a process comprising:
depositing a thin film of a concentrated aqueous nano titania sol onto at least a portion of the substrate, wherein the concentrated aqueous nano titania sol is formed by the process comprising:
(a) contacting an acidic nano titania sol with: (i) a dispersant comprising a water soluble carboxylic acid, a water soluble salt of a carboxylic acid, a water soluble polycarboxylic acid, or combinations thereof; and (ii) an alkalizing agent, thereby forming a pH adjusted nano titania sol, wherein the pH adjusted nano titania sol has a pH in a range of between about 4.0 and about 10.0; and
(b) subjecting the pH adjusted nano titania sol to membrane filtration and continuing such membrane filtration until the pH adjusted nano titania sol contains more than 300 g TiO₂ nanoparticles/dm³, thereby forming the concentrated aqueous nano titania sol;
exposing at least a portion of the deposited film to a sufficient amount of ultraviolet radiation in order to gel the concentrated aqueous nano titania sol;
optionally, drying at least a portion of the gelled portion of the concentrated aqueous nano titania sol; and
exposing at least a portion of the gelled portion or optionally dried portion to thermal treatment, thereby forming the coating layer.

16. A coating composition formed by the process comprising:
(a) contacting an acidic nano titania sol doped with up to 20% of elements from groups VA & VB of the periodic table with: (i) a dispersant comprising a water soluble carboxylic acid, a water soluble salt of a carboxylic acid, a water soluble polycarboxylic acid, or combinations thereof; and (ii) an alkalizing agent, thereby forming a pH adjusted nano titania sol, wherein the pH adjusted nano titania sol has a pH in a range of between about 4.0 and about 10.0; and
(b) subjecting the pH adjusted nano titania sol to membrane filtration and continuing such membrane filtration until the pH adjusted nano titania sol contains more than 300 g TiO₂ nanoparticles/dm³, thereby forming the coating composition.
